(19) United States
(12) Patent Application Publication
(10) Pub. No.: US 2023/0008652 A1
(43) Pub. Date: Jan. 12, 2023

(54) LIVESTOCK HEAD COVERING

(71) Applicants: Sarah Mary WEITZEL, Charlie Lake (CA); Georg Sieghard WEITZEL, Charlie Lake (CA)

(72) Inventors: Sarah Mary WEITZEL, Charlie Lake (CA); Georg Sieghard WEITZEL, Charlie Lake (CA)

(21) Appl. No.: 17/810,450

(22) Filed: Jul. 1, 2022

Related U.S. Application Data
(63) Continuation-in-part of application No. 29/791,265, filed on Jan. 6, 2022.

(30) Foreign Application Priority Data
Jul. 7, 2021 (CA) 204766
Jul. 19, 2021 (CA) CA 3125334

(51) Int. Cl. A01K 13/00; A01K 11/00

(52) U.S. Cl. CPC A01K 13/006; A01K 11/001

(57) ABSTRACT

A head covering for protecting the head and ears of a livestock animal such as cattle, goats and sheep is described. The head covering includes a main sleeve formed of stretchable fabric and defined by a neck opening, a snout opening, a pair of ear openings and a pair of eye openings. The main sleeve is stretchable radially around the head and the snout of the livestock animal. The head covering includes a pair of elongated ear covers formed of stretchable fabric. The ear covers are connected to the main sleeve adjacent to peripheral edges of the ear openings. The head covering is particularly useful in operations involving raising livestock in cold weather conditions, for prevention of frostbite on the ears.

### CROSS-REFERENCE TO RELATED APPLICATIONS

This application claims priority from Canadian Industrial Design Application No. 204766 filed Jul. 7, 2021, Canadian Pat. Application No. 3,125,334 filed Jul. 19, 2021 and U.S. Design Pat. Application No. 29/791,265 filed Jan. 6, 2022, the entire disclosures of which are incorporated herein by reference.

### FIELD OF THE INVENTION

The invention relates to protective clothing for animals, and more particularly to a head covering for livestock animals such as cattle, goats and sheep.

### BACKGROUND

The process of raising livestock in extreme cold weather conditions raises the risk of frostbite to sensitive areas of animals, such as the ears. This problem is particularly serious for newborn and young animals, which have less of a protective coat in these sensitive areas. The resulting injuries from frostbite significantly affects the health and well-being of the animals.

Efforts to protect livestock animals have resulted in production of protective head coverings. Two notable examples are head coverings which are marketed as “Moo Muffs” (www.moomuffs.com) and Bala-Calfa™ (www.bala-calfa.com). The Moo Muffs head covering product includes a snout band connected to a head band by an upper strip. The head band is connected to a pair of ear coverings which provide a loose fit over the ears of the livestock animal. The Bala-Calfa™ product resembles a classical ski mask worn by humans in providing a snug fit over the head of the livestock animal without ear coverings.

There remains a need for improvements in livestock head coverings which contribute to the health and well-being of livestock animals.

### SUMMARY

According to one embodiment, there is provided a head covering for protecting the head and ears of a livestock animal. The head covering includes a main sleeve formed of stretchable fabric and defined by a neck opening, a snout opening, a pair of ear openings and a pair of eye openings. The main sleeve is stretchable radially around the head and the snout of the livestock animal. The head covering includes a pair of elongated ear covers formed of stretchable fabric. The ear covers are connected to the main sleeve adjacent to peripheral edges of the ear openings.

According to another embodiment, there is provided a head covering for protecting the head and ears of a livestock animal which includes a main sleeve defined by a neck opening, a snout opening, a pair of ear openings and a pair of eye openings. The head covering includes a pair of elongated ear covers connected to the main sleeve adjacent to peripheral edges of the ear openings. An identification patch is connected to one of the ear covers. The identification patch, may be provided with an outer surface compatible with an erasable marker.

The identification patch may be formed of leather or imitation leather, and the erasable marker may be a wax-based pencil.

In some embodiments, the ear covers are stretchable laterally with respect to a longitudinal axis of the ear covers, to facilitate placement of the ears of the livestock animal therein.

Each ear cover of the pair of ear covers may be constructed by connecting perimeter edges of two equivalent ear cover panels together to form a continuous seam extending around the entire ear cover, wherein the continuous seam joins upper and lower portions of the peripheral edge of each ear opening of the pair of ear openings.

In some embodiments, the main sleeve is shaped to cover the top of the head of the livestock animal.

The main sleeve may be constructed by connecting free ends of two equivalent main sleeve panels together to form upper and lower seams which extend between the neck opening and the snout opening, wherein the upper seam is substantially aligned with a medial plane of the head of the livestock animal when the head covering is worn by the livestock animal and wherein the two equivalent panels stretch between the upper seam and the lower seam to a greater extent than between edges of the neck opening and the snout opening.

In some embodiments, each ear opening of the pair of ear openings is expandable by radially stretching the main sleeve to further facilitate placement of the ears of the livestock animal therein.

In some embodiments, each eye opening of the pair of eye openings is expandable by stretching the main sleeve along the main stretching axis.

In some embodiments, the head covering also includes a neck band connected to the main sleeve adjacent the neck opening. The neck band includes two or more sets of complementary fasteners and a free ends for adjusting an effective radius of the neck opening by overlapping a portion of the neck band. The complementary fasteners may be snap buttons.

In some embodiments, tightening adjustment of the neck band generates radial stretching of the main sleeve.

The neck band, the main sleeve and the ear covers may be formed of polar fleece material and the head covering may be provided with an outer surface having a water-resistant coating.

The head covering may be provided with dimensions configured for fitting cattle, sheep or goats.

In some embodiments, as an alternative to an identification patch configured for marking with an erasable marker, one of the ear covers is defined by a forward facing slot configured to permit removal of a livestock identification tag connected to an ear of the livestock animal, when the head covering is worn by the livestock animal.

In some embodiments, when the head covering is configured for cattle, the snout opening has a diameter of about 8 cm to about 11 cm, which is stretchable radially to increase the snout opening diameter by about 8% to about 11%.

In some embodiments, when the head covering is configured for cattle, the ear openings each have a diameter of about 5.5 cm to about 7.5 cm, which is stretchable radially to increase the ear opening diameter by about 8% to about 11%.

In some embodiments, when the head covering is configured for cattle, the ear covers each have a length of about 13 cm to about 17 cm.

In some embodiments, when the head covering is configured for cattle, the ear covers have a width of about 8.5 cm to about 9.5 cm, which is stretchable laterally to increase the width of the ear covers by about 8% to about 11%.

Another aspect of the present technology is kit comprising the head covering according to any embodiment described herein which includes an identification patch connected to an ear cover, and an erasable marker. The identification patch may be formed of imitation leather and the erasable marker may be a wax-based pencil.

### BRIEF DESCRIPTION OF THE DRAWINGS

Various objects, features and advantages of the invention will be apparent from the following description of particular embodiments of the invention, as illustrated in the accompanying drawings. Emphasis instead being placed upon illustrating the principles of various embodiments. Similar reference numerals indicate similar components.

FIG. 1 is a perspective view of one embodiment of a livestock head covering 10 as worn by a livestock animal, whose anatomy is shown in dashed lines.

FIG. 2 is a front elevation view of the livestock head covering 10 as worn by the livestock animal.

FIG. 3 is a back elevation view of the livestock head covering 10 as worn by the livestock animal.

FIG. 4 is a left side elevation view of the livestock head covering 10 as worn by the livestock animal.

FIG. 5 is a top view of the livestock head covering 10 as worn by the livestock animal.

FIG. 6 is a bottom view of the livestock head covering 10 as worn by the livestock animal.

FIG. 7 is a partial view of an inner surface of the livestock head covering 10 indicating a notch 37 in the neck band 24 of the livestock head covering 10 to provide free ends 38A and 38B of the neck band 24.

FIG. 8A is a perspective view of another embodiment of a livestock head covering 100 which has an alternative patch 126 with a slit 127 replacing the ID patch 26 of embodiment 10.

FIG. 8B is the same perspective view of embodiment 100 illustrating an ear tag T extending from the slit 127.

### DETAILED DESCRIPTION

### Introduction and Rationale

As noted in the background section, the problem of frostbitten ears of young livestock animals occurring in extreme cold conditions has been recognized as leading to problems including severe discomfort and reduction in prices offered for livestock with frozen ears. The inventors of the present patent application have established that previous commercial attempt to address this problem have been unsatisfactory. The inventors have a cattle operation in northeastern British Columbia, Canada which involves raising cattle in extreme cold conditions with temperatures as low as -45° C. during the winter season. In attempting to address this frostbite problem, the inventors have tested both the Moo Muffs and Bala-Calfa™ products.

It was determined that the ear coverings of the Moo Muffs product are not formed of stretchable fabric and therefore do not provide a snug fit to promote insulation from the cold. The nose band tends slip and cause the rear head band to slip backwards, leaving the ears exposed. Adjustment of the sizing straps tends to be time consuming. In addition, when installed correctly, this product leaves a significant portion of the animal’s head exposed. The inventors have recognized that it is common behavior for a cow to lick the forehead of its calf, generating wet hair which will freeze quickly in cold temperatures and cause significant discomfort to the animal.

The Bala-Calfa™ livestock head covering appears to protect livestock ears from the cold but causes other problems. Because this product does not have ear coverings, the ears of the livestock animal are required to be unnaturally compressed against its head by the head covering in a manner similar to a human wearing a traditional knitted ski mask. This unnatural arrangement causes significant discomfort to the calf, which can lead to a failure to feed appropriately and thrive. This compression of ears can also cause irritation, leading to sores and infections which require expensive veterinary treatments.

In addressing the problems described above, the inventors have conceived of inventive improvements in livestock head coverings, which are described below in context of example embodiments. The livestock head covering embodiments are conveniently installed and removed, adjustable and stretchable to provide different sizing, as well as being machine washable and reusable. These embodiments and can be produced in an economical manner by garment manufacturers. Certain embodiments include an identification tag feature configured to permit marking and erasing identification markings to ensure smooth livestock maintenance operations.

While the example embodiments were developed for fitting to cattle, dimensions may be altered appropriately to fit other livestock animals such as sheep or goats, for example.

Various aspects of the example embodiments will now be described with reference to the figures. Emphasis is placed on highlighting the various contributions of the components to the functionality of various aspects of these embodiments. A number of possible alternative features are introduced during the course of this description. It is to be understood that, according to the knowledge and judgment of persons skilled in the art, such alternative features may be substituted in various combinations to arrive at different embodiments.

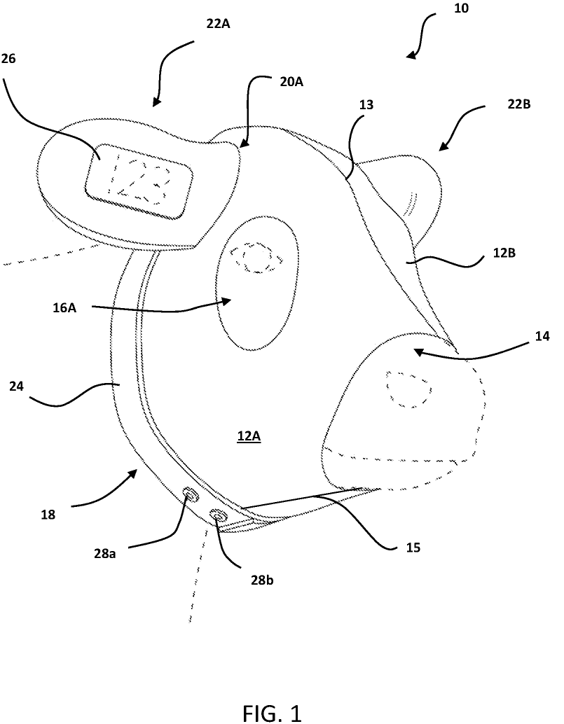

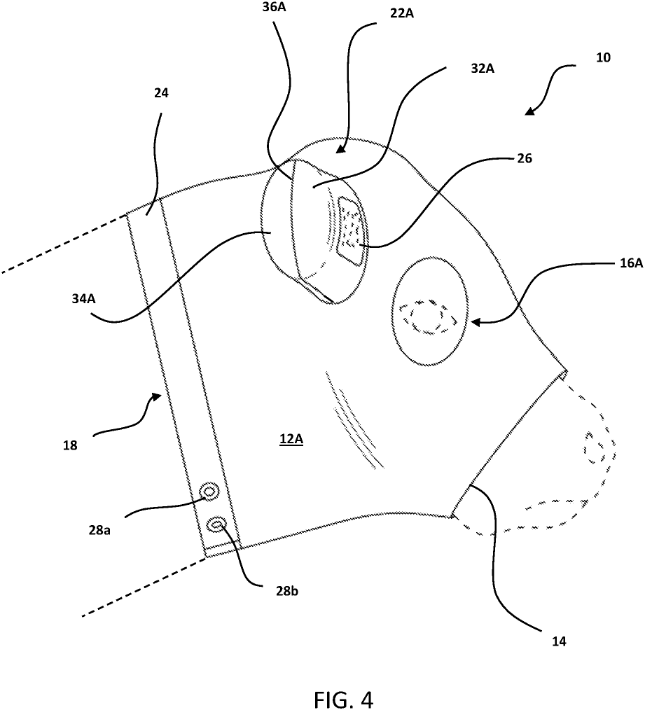

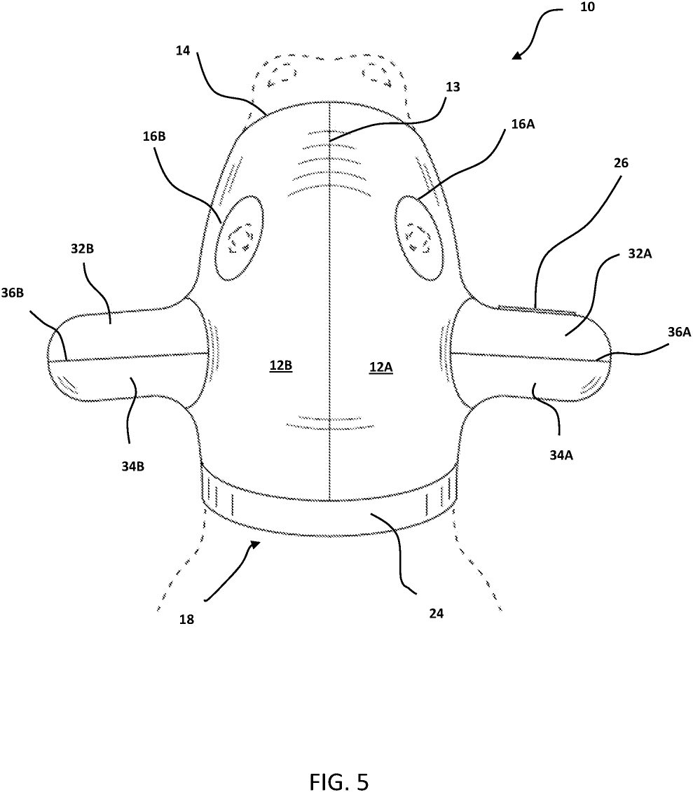

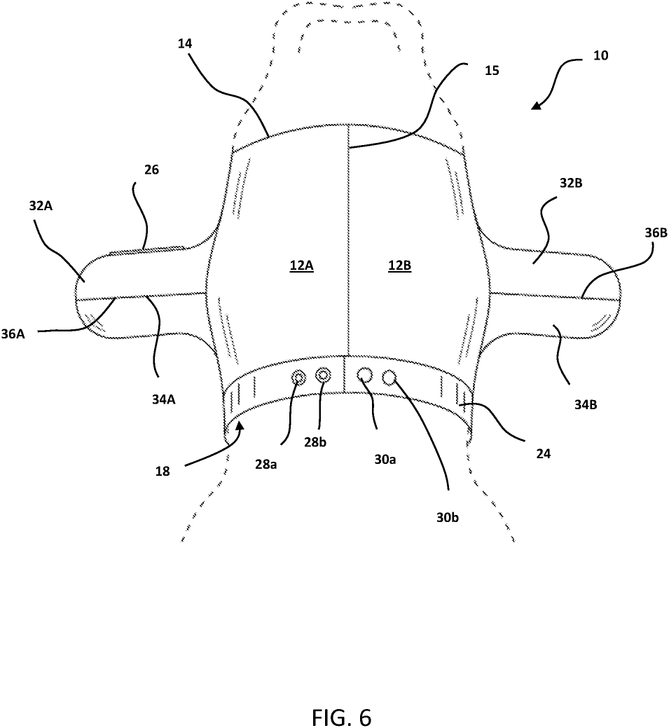

Referring to FIGS. 1 to 6, there is shown a first example embodiment of a livestock head covering 10 in a series of different views. In the orientation of the livestock head covering 10 shown in FIG. 1, matched pairs of features are designated using sublabels A for the left side and B for the right side. The livestock head covering 10 includes a main sleeve which, in this particular embodiment, is formed of two separate sleeve panels 12A and 12B. The sleeve panels 12A and 12B are formed such that, when connected to each other at the top and bottom edges, by sewing, for example, to form an upper seam 13 which is substantially aligned with a medial plane of the head of the livestock animal and a lower seam 15, the main sleeve forms a snout opening 14 and a neck opening 18, which is adjustable, as described in more detail below. In some embodiments, the snout opening 14 may have a diameter of about 8 cm to about 11 cm. It is seen in FIGS. 1 to 6 that the livestock head covering 10 is configured to cover the entire forehead of the livestock animal. This is a useful feature in terms of protecting cattle because the inventors have determined that a mother cow will often lick the forehead of its calf and the wet hide will then freeze in extreme cold temperatures, leading to significant discomfort for the calf.

It is advantageous for the sleeve panels 12A and 12B to have greater stretching capacity between the upper and lower seams 13 and 15 than between the snout opening 14 and the neck opening 18 because this arrangement contributes to radial stretching of the head covering as described in more detail below.

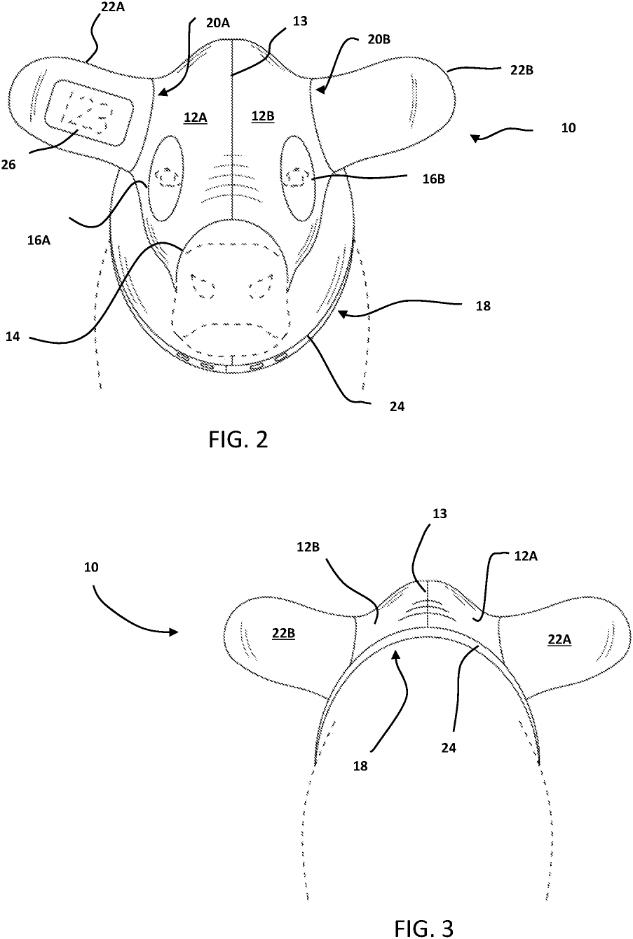

A pair of eye openings 16A and 16B are formed in the sleeve panels 12A and 12B. The sleeve panels 12A and 12B also have ear openings 20A and 20B which themselves are not visible by virtue of ear coverings 22A and 22B being attached to peripheral edges thereof (for example by sewing or other attachment means), but whose positions are indicated in FIG. 2, generally at the boundary between the sleeve panels 12A and 12B and the connecting edges of the ear coverings 22A and 22B. The ear openings 20A and 20B permit the ears of the livestock animal to emerge from the main sleeve and to enter the ear coverings 22A and 22B. In some embodiments, the ear openings are generally circular, each with a diameter of about 5.5 cm to about 7.5 cm. Advantageously, the ear openings are stretchable radially to facilitate placement of the animal’s ears therein. Likewise, the eye openings 16A and 16B are radially stretchable to provide additional space between edges of the eye openings 16A and 16B and the eyes of the animal to prevent eye irritation which could occur with closer spacing.

As best seen in FIG. 2, panel 12A (as well as matched panel 12B, which is not visible in this view) are shaped to conform to the head of the animal. As a result, the panels 12A and 12B each have a top edge which extends generally horizontally from the neck opening 18 to a point above and in front of the ear covering and which is subsequently angled downward to substantially match to the continuous slope of the animal’s face extending from the forehead to the snout. This shape has the effect of making the snout opening 14 angled downwards relative to a longitudinal axis passing through the neck of the animal. This conformation contributes to effective fit, adjustability and provides more comfort to the animal than a head covering based on a simple tube-shaped sleeve with concentric neck and snout openings.

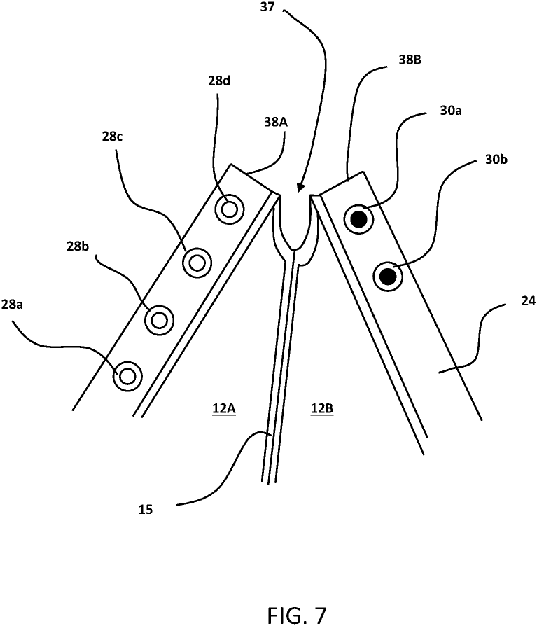

The livestock head covering 10 includes an adjustable neck band 24 at the periphery of the neck opening 18. In this particular embodiment, the neck band includes a series of fasteners 28a-d and 30a,b. Functionality of these fasteners 28a-d and 30a,b will be described in more detail below in context of FIG. 7. Other fastener arrangements are possible and are envisioned as being within the scope of the claims of this patent application. The neck band 24 is connected to the sleeve panels 12A and 12B by sewing or other connection means such that tensioning to tighten the neck band 24 results in radial stretching of the main sleeve formed by the sleeve panels 12A and 12B.

Another feature of the livestock head covering embodiment 10 is an external identification patch 26. The identification patch 26 is provided to permit the operators to copy the identification number from an ear tag of the animal being fitted with the livestock head covering in order to permit continued identification of the animal while the ear tag is contained within the ear covering 22A. While only one identification patch 26 is shown in the embodiments described herein, alternative embodiments which provide an identification patch on each ear covering 22A and 22B are also within the scope of the claims. In some embodiments, the identification patch is formed of a material which permits identification markings to be erased. Imitation leather patches have been found useful for this purpose and are compatible with wax-based markers such as eyeliner pencils which are easily sourced. One example of such a wax-based marker is a marker known as an “eyeliner pencil” used in cosmetics. Eyeliner pencils are based on colored waxes such as C₁₀-C₁₈ triglycerides, for example. The use of an eyeliner pencil to provide markings on an imitation leather patch has been found to provide clearly visible markings which are resistant to moisture and smudging under various conditions. The markings formed in this manner may be erased by rubbing with a damp cloth.

In this particular embodiment 10, the ear coverings 22A and 22B are formed from front ear covering panels 32A and 32B joined to corresponding back ear covering panels 34A and 34B by sewing or other attachment means to form a continuous seams 36A and 36B for each ear covering of the pair of ear coverings 22A and 22B. In some embodiments the ear covers have a length between about 13 cm to about 17 cm. In some embodiments, the ear covers have a width of about 8.5 cm to about 9.5 cm.

The identification patch 26 is a useful feature because identification failures which could occur as a result of using a livestock head covering without an identification patch can lead to significant inefficiencies in maintaining smooth cattle production operations. In one such example, a failure to identify a calf properly may lead to delays in ensuring that it bonds properly with its mother. In such cases, significant extra time is required to provide an alternative arrangement to ensure that it is properly fed in order to thrive. The ability to conveniently provide identification markings matching those of a prior-installed ear tag on the identification patch 26 at the time of installation of the head covering 10 on a young animal will mitigate identification failures and lead to more efficient operations.

In embodiment 10 and other embodiments, it is advantageous for the main sleeve formed of the panels 12A and 12B and the ear coverings 22A and 22B to be formed of stretchable material with good insulation properties. The material known in the art as “polar fleece” has been recognized by the inventors as being suitable material for forming the sleeve panels 12A and 12B, the connected ear coverings 22A and 22B and the neck band 24. As used herein, the term “fleece” refers to any blend of cotton and polyester, which may optionally include other materials formed from polyurethanes such as Lycra®, spandex or other polymers suitable for forming knit fabrics.

In some embodiments, the material used to form the sleeve panels 12A and 12B and the ear coverings 22A and 22B has an outer surface coated with a water resistant surface coating, to repel water, thereby providing additional protection to the animal.

In some embodiments, the material is arranged to provide a suitable degree of stretchability of at least about 8% or between about 8% to about 11% relative to an unstretched form, to facilitate the process of installing the livestock head covering over the head of a livestock animal with minimal effort. In one example of installation of embodiment 10 of the livestock head covering, the main sleeve is compressed such that the neck opening 24 and the snout opening 14 can be grasped together and stretched radially to permit the operator to insert the head of the livestock animal into the main sleeve such that the snout of the animal protrudes through the snout opening 14. Then the main sleeve is stretched so that the eye openings 16A and 16B are aligned over the eyes of the animal. The ears of the animal are then tucked into the ear coverings 22A and 22B before the neck opening 18 is pulled towards the back of the neck of the animal. Lastly, the neck band 24 may be adjusted for appropriate fit, if necessary, as described in more detail below. If the fit is sufficient, no adjustment is required. The inventors have determined that entire process of fitting a calf with the livestock head covering embodiment 10 requires less than 30 seconds of time. This provides is a significant advantage in efficient protection and care of large herds of young cattle.

Turning now to FIG. 7, there is shown a partial view of the inside of the main sleeve on the underside of embodiment 10. It is seen that the sleeve panels 12A and 12B are connected by lower seam 15 and that the neck band 24 is connected to the peripheral edges of the panels 12A and 12B. On panel 12A, there is a series of four fasteners 28a-d and on panel 12B there are two complementary fasteners 30a,b. In this particular embodiment, the fasteners 28a-d and 30a,b are conventional rust-resistant snap button fasteners. The lower seam 15 ends before reaching a corner edge between the two panels 12A and 12B, forming a notch 37 which defines free ends 38A and 38B of the neck band 24. This arrangement permits overlap of end portions of the neck band 24 to make a smaller or larger radius of the neck band 24 and the resulting neck opening 18. The largest neck opening radius is provided when no fastener connections are made. The smallest neck opening radius is provided when fastener 30b is connected to fastener 28a to provide maximal overlap of portions of the neck band 24. Other connections between different fasteners will provide different neck opening radii. It has been determined through experimentation that the adjustable neck band 24 is a useful feature as a result of different neck sizes among young cattle of the same breed or between different breeds. It has also been determined through experimentation that certain alternative fastening mechanisms such as hook and loop fasteners (e.g. Velcro® have significant drawbacks such as becoming contaminated with hair, dirt and other debris, which reduces their functionality). As a result, conventional stainless steel snap button fasteners are preferred. In some embodiments, the diameter of the opening may be adjustable from a diameter of about 20 cm to about 10 cm, and including any diameter therebetween.

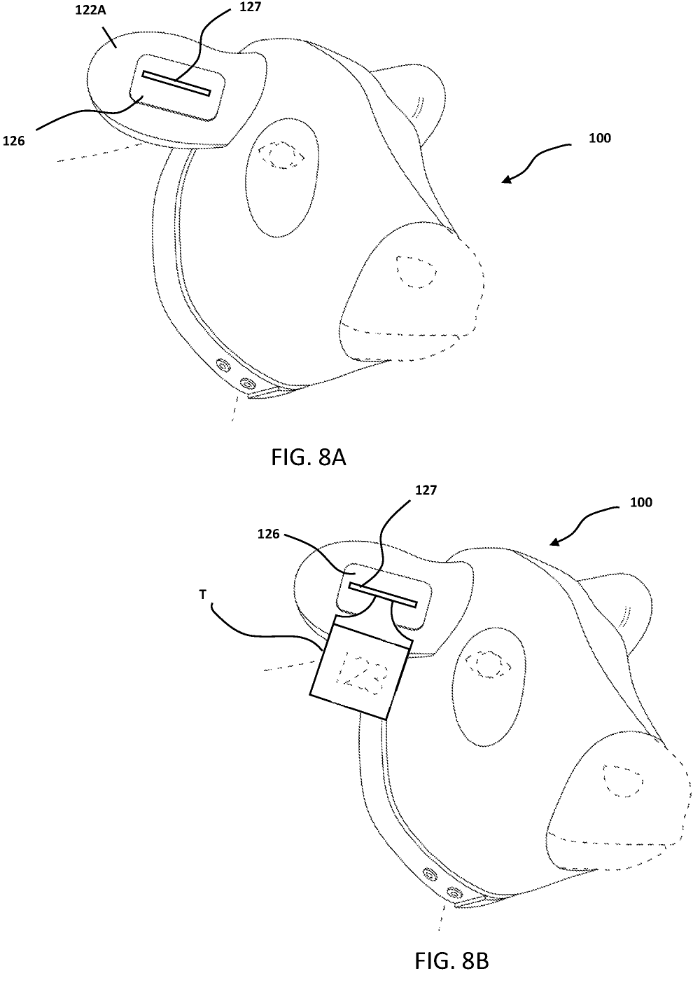

An alternative livestock head covering embodiment 100 is illustrated in FIGS. 8A and 8B. This embodiment 100 is generally similar to embodiment 10 of FIGS. 1 to 7 with the exception of having an alternative patch 126 installed on ear covering 122A. This alternative patch 126 is advantageously formed of an elastomeric material such as neoprene, for example which is placed over an opening in the ear covering 122A and connected to the ear covering 122A. This patch 126 includes a stretchable slit 127 which permits an operator to expand the slit and withdraw an ear tag T from the ear covering 122A such that it extends and hangs downward from the slit 127 as shown in FIG. 8B. Advantageously the elastomeric material is biased to minimize the width of the slit 127 in order to maximize the protective insulation provided by the ear covering 122A.

Embodiments of the livestock head covering which include an identification patch may be provided in a commercial kit package that includes a marker which provides markings that are erasable from the identification patch. In some embodiments, the identification patch is made of imitation leather material which is water resistant and the marker is a wax pencil. The kit may also include instructions for installing the livestock head cover over the head of a livestock animal and for making adjustments of the radius of the neck opening.

### Equivalents and Scope

Other than described herein, or unless otherwise expressly specified, all of the numerical ranges, amounts, values and percentages in the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect +/- 10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

1. A head covering for protecting the head and ears of a livestock animal, the head covering comprising:
a main sleeve formed of stretchable fabric and defined by a neck opening, a snout opening, a pair of ear openings and a pair of eye openings, the main sleeve stretchable radially around the head and the snout of the livestock animal; and
a pair of elongated ear covers formed of stretchable fabric, the ear covers connected to the main sleeve adjacent to peripheral edges of the ear openings.

2. The head covering of claim 1, wherein the ear covers are stretchable laterally with respect to a longitudinal axis of the ear covers, to facilitate placement of the ears of the livestock animal therein.

3. The head covering of claim 1, wherein each ear cover of the pair of ear covers is constructed by connecting perimeter edges of two equivalent ear cover panels together to form a continuous seam extending around the entire ear cover, wherein the continuous seam joins upper and lower portions of the peripheral edge of each ear opening of the pair of ear openings.

4. The head covering of claim 1, wherein the main sleeve is shaped to cover the top of the head of the livestock animal.

5. The head covering of claim 1, wherein the main sleeve is constructed by connecting free ends of two equivalent main sleeve panels together to form upper and lower seams which extend between the neck opening and the snout opening, wherein the upper seam is substantially aligned with a medial plane of the head of the livestock animal when the head covering is worn by the livestock animal and wherein the two equivalent panels stretch between the upper seam and the lower seam to a greater extent than between edges of the neck opening and the snout opening.

6. The head covering of claim 1, wherein each ear opening of the pair of ear openings is expandable by radially stretching the main sleeve to further facilitate placement of the ears of the livestock animal therein.

7. The head covering of claim 1, wherein each eye opening of the pair of eye openings is expandable by stretching the main sleeve along the main stretching axis.

8. The head covering of claim 1, further comprising a neck band connected to the main sleeve adjacent the neck opening, the neck band comprising two or more sets of complementary fasteners and a free ends for adjusting an effective radius of the neck opening by overlapping a portion of the neck band.

9. The head covering of claim 8, wherein the complementary fasteners are snap buttons.

10. The head covering of claim 8, wherein tightening adjustment of the neck band generates radial stretching of the main sleeve.

11. The head covering of claim 8, wherein the neck band is formed of polar fleece material.

12. The head covering of claim 1, wherein the main sleeve and the ear covers are formed of polar fleece material.

13. The head covering of claim 1, having an outer surface with a water-resistant coating.

14. The head covering of claim 1, having dimensions configured for a livestock animal selected from the group consisting of: cattle, sheep and goats.

15. The head covering of claim 1, further comprising an identification patch connected to one of the ear covers, the identification patch, having an outer surface compatible with an erasable marker.

16. The head covering of claim 15, wherein the identification patch is formed of leather or imitation leather, and the erasable marker is a wax-based pencil.

17. The head covering of claim 1, wherein one of the ear covers is defined by a forward facing slot configured to permit removal of a livestock identification tag connected to an ear of the livestock animal, when the head covering is worn by the livestock animal.

18. The head covering of claim 1, configured for cattle, wherein the ear covers each have a length of about 13 cm to about 17 cm.

19. A kit comprising the head covering of claim 15 and an erasable marker.

20. The kit of claim 19, wherein the erasable marker is a wax-based pencil.
